(19) United States
(12) Patent Application Publication
(10) Pub. No.: US 2003/0163582 A1
(43) Pub. Date: Aug. 28, 2003

(54) Network device and network management device

(76) Inventors: Rumiko Inoue, Kawasaki (JP); Satoshi Tsuchiya, Kawasaki (JP); Koichi Takeda, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/269,540

(22) Filed: Oct. 11, 2002

(30) Foreign Application Priority Data
Feb. 15, 2002 (JP) 2002-039256

(51) Int. Cl. G06F 15/173

(52) U.S. Cl. 709/238; 709/223

(57) ABSTRACT

In a network device and a network management device managing the network device, network management processors of the network devices transmit management information of their own devices in a format displayable on the browser, e.g. XML or HTML upon occurrence of a predetermined event, and a network management processor of the network management device displays the management information.

### BACKGROUND OF THE INVENTION

1. Field of the Invention

The present invention relates to a network device and a network management device, and in particular to a network device and a network management device managing the network device.

Recently, together with a rapid spread of communication, a large-scale network formed of small-scale networks, constructed for applications or services, such as Ethernet or intranet mutually connected has been increasing. To this network, network devices of various makers are connected, so that it is important to manage such network devices.

2. Description of the Related Art

FIG. 9 shows an arrangement of a general network, which is composed of sub-networks 40_1-40_3. The sub-networks 40_2 and 40_3 are connected to the sub-network 40_1 respectively with network devices (e.g. routers) 10a_1 and 10a_2 (hereinafter, occasionally represented by a reference numeral 10a).

A network management device (server) 20a and a Web server 30 are connected to the sub-network 40_1. Clients 50_1 and 50_2 are respectively connected to the sub-networks 40_2 and 40_3.

[1] SNMP-Based Network Management

The network management device 20a manages the network device 10a with SNMP (Simple Network Management Protocol: protocol for a network management prescribed with RFC1157).

An agent (not shown) included in the network device 10a notifies to the network management device 20a management information defined with MIB (Management Information Base) for a request from a manager (not shown) included in the network management device 20a.

A management information processor or application (not shown) of the network management device 20a produces a screen display, an error display, or the like based on the management information from the network device 10a.

[2] WWW-Based Network Management

In the prior art network management system disclosed in the Japanese Patent Application Laid-open No.11-239136, a network device 10a mounts thereon a function of converting management information of its own device into an HTML document of a data format which can be referred to by WWW (World Wide Web), and a WWW server offering the converted management information.

A network management device 20a mounts thereon a WWW browser, and browses the management information of the network device 10a by accessing the WWW server.

In the prior art SNMP-based network management system, when the network device 10a having new unique information (called expansion MIB) is managed, the expanded MIB had to be newly reflected to the application of the network management device 20a.

Also, in the WWW-based network management system, the network device 10a was required to mount thereon the WWW server.

Furthermore, in the SNMP-based and the WWW-based network management systems, the network management device 20a was generally required to obtain the management information from the network device 10a by means of polling.

### SUMMARY OF THE INVENTION

It is accordingly an object of the present invention to provide a network device and a network management device managing the network device, thereby carrying out managements which can easily accommodate to management information unique to the network devices.

In order to achieve the above-mentioned object, a network device according to the present invention comprises: a network management processor for preparing management information of its own device in a format displayable on a browser upon occurrence of a predetermined event; and a transmitter for transmitting the management information (claim 1).

Namely, a network device independently transmits management information of its own device by a format displayable on a browser, e.g. HTML (Hyper Text Markup Language), XML (eXtensible Markup Language), or the like upon occurrence of a predetermined event.

Thus, it becomes possible for the network device to easily transmit e.g. the management information of its own device to a network management device. Also, the network device can transmit optimal management information for the management of its own device, unique management information, and the like by the optimal display format.

Also, in the present invention according to the above-mentioned present invention, the network management processor may comprise a management information storage for storing or holding the management information and a management information generator for generating management information of a format displayable on the browser based on the management information (claim 2).

Namely, a management information storage holds the management information of its own device. A management information generator refers to the management information held in the management information storage to generate management information of a format displayable on the browser.

Also, in the present invention according to the above-mentioned present invention, the format displayable on the browser may comprise an HTML or an XML (claim 3).

Also, in the present invention according to the above-mentioned present invention, an attribute may be added to the management information (claim 4).

Thus, it becomes possible to classify the management information by the attribute.

Also, in the present invention according to the above-mentioned present invention, the occurrence of the predetermined event may comprise at least one of a time of a startup, a time of a management information change, or a predetermined period (claim 5).

Namely, the network device can transmit the management information of its own device when its own device starts up, when the management information of its own device changes, or at a predetermined period.

Furthermore, in the present invention according to the above-mentioned present invention, the occurrence of the predetermined event may comprise a time when a management information request packet is received from a network management device (claim 6).

Also, in order to achieve the above-mentioned object, a network management device according to the present invention comprises: a receiver for receiving management information of a format displayable on a browser transmitted from a network device upon occurrence of a predetermined event; and a network management processor for displaying the management information (claim 7).

Namely, a network management processor receives and displays management information of a format displayable on a browser transmitted from a network device upon occurrence of a predetermined event.

Thus, the network management device is provided with the network management processor having only a minimum browser function, and can manage the network device. Also, it becomes possible for the network management processor to manage e.g. the management information unique to a newly added network device without changing a management application.

Also, in the present invention according to the above-mentioned present invention, the network management processor may have a management information storage for storing received management information of the format and a management information processor for displaying management information based on the management information (claim 8).

Namely, a management information storage stores the management information of the format received from the network device, and a management information processor displays the management information.

Also, in the present invention according to the above-mentioned present invention, the network management processor may generate a management information request packet requesting management information determined to be necessary and may transmit the packet to the network device (claim 9).

Namely, when determining that the management information for a certain network device is necessary, such as at a time of power-on, a reset, a specific time such as noon, or when determining that there is necessary management information based on inputted management information, the network management processor (network management application) generates a management information request packet and transmits the same to the network device. Thus, it becomes possible for the management information processor to obtain necessary management information.

Also, in the present invention according to the above-mentioned present invention, the network management device may further comprise a management information generator for transmitting a management information request packet requesting the management information to the network device, when subsequent management information is not received from the network device after the management information of the network device is received and a predetermined time elapses (claim 10).

Namely, after receiving the management information from a certain network device, a management information generator transmits a management information request to the network device when the subsequent management information is not received from the network device after a predetermined time elapses.

Thus, it becomes possible for the network management device to request the management information from the network device.

Also, in the present invention according to the above-mentioned present invention, the management information processor may display each management information from a plurality of network devices respectively on a window screen corresponding to each network device (claim 11).

Namely, it becomes possible for the management information processor to display the management information of a plurality of network devices simultaneously tiled on the screen.

Furthermore, in the present invention according to the above-mentioned present invention, the management information processor may display the management information based on an attribute added to the management information of the format (claim 12).

Namely, when an attribute “alarm” is added to the management information, for example, it becomes possible for the management information processor to give an alarm sound.

### BRIEF DESCRIPTION OF THE DRAWINGS

The above and other objects and advantages of the invention will be apparent upon consideration of the following detailed description, taken in conjunction with the accompanying drawings, in which the reference numbers refer to like parts throughout and in which:

FIG. 1 is a block diagram showing an embodiment of a network device according to the present invention;

FIG. 2 is a block diagram showing an embodiment of a network management device according to the present invention;

FIG. 3 is a diagram showing a network example composed of a network device and a network management device according to the present invention;

FIGS. 4A and 4B are diagrams showing an example of a management information notification packet and an example of management information according to the present invention;

FIGS. 5A-5C are diagrams showing an example of a management screen of a display in a network management device according to the present invention;

FIG. 6 is a flow chart showing an operation procedure of a network device according to the present invention;

FIG. 7 is a flow chart showing an operation procedure of a network management device according to the present invention;

FIG. 8 is a sequence diagram showing an operation procedure example between a network device and a network management device according to the present invention; and

FIG. 9 is a block diagram showing a general network arrangement.

### DESCRIPTION OF THE EMBODIMENTS

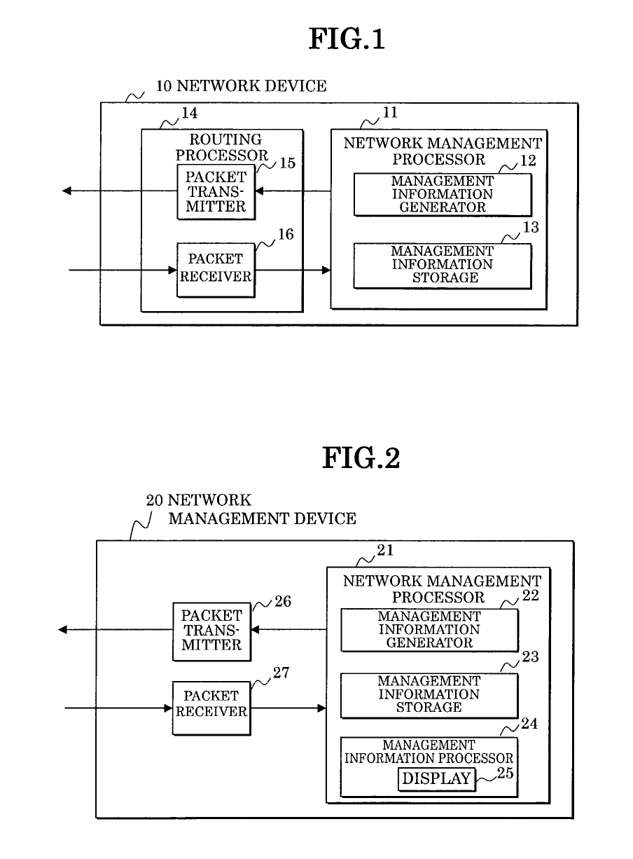

FIG. 1 shows an embodiment of a network device 10 according to the present invention. This network device 10 is, for example, a router, and is provided with a network management processor 11 and a routing processor 14. The network management processor 11 is provided with a management information generator 12 and a management information storage 13. The routing processor 14 is provided with a packet transmitter 15 and a packet receiver 16.

FIG. 2 shows an embodiment of a network management device 20 according to the present invention. This network management device 20 is, for example, a server, and is provided with a network management processor 21, a packet transmitter 26, and a packet receiver 27. The network management processor 21 is provided with a management information generator 22, a management information storage 23, and a management information processor 24. This management information processor 24 includes a display 25.

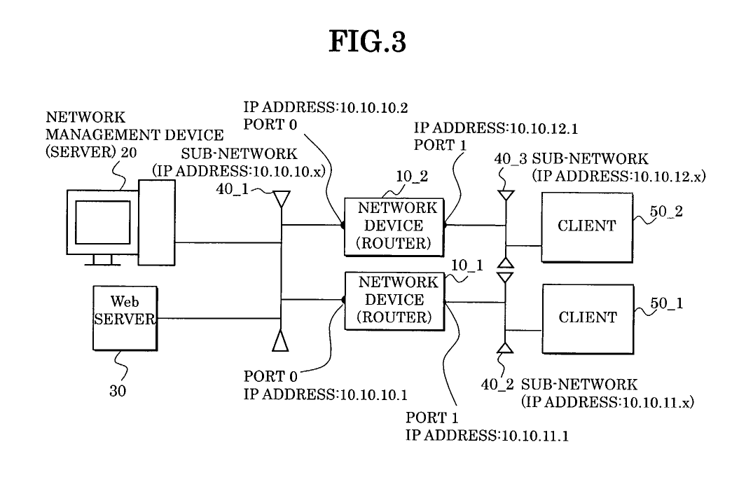

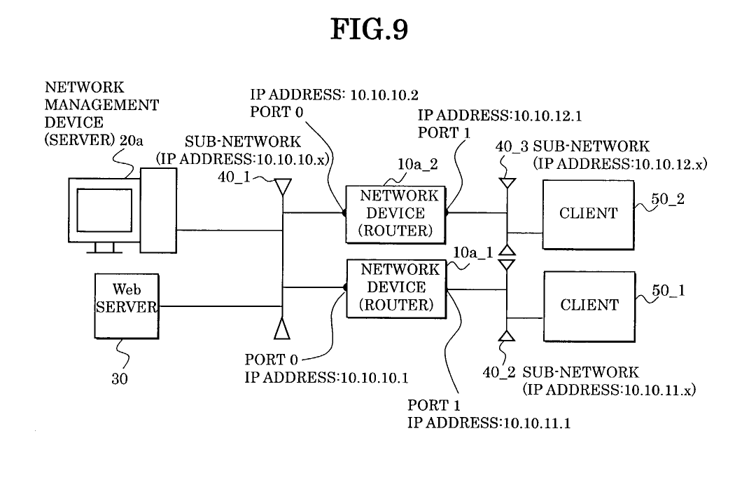

FIG. 3 shows a network example including the network device 10 and the network management device 20 according to the present invention. While the arrangement of this network is the same as a general network arrangement shown in FIG. 9, in FIG. 3 network devices (routers or the like) 10_1 and 10_2, and the network management device (server) 20 according to the present invention are substituted for the prior art network devices 10a_1, 10a_2, and network management device 20a.

The router 10_1 is connected to sub-networks 40_1 and 40_2 respectively through ports 0 and 1. The router 10_2 is connected to sub-networks 40_1 and 40_3 respectively through the ports 0 and 1.

The IP addresses of the sub-networks 40_1-40_3 are respectively (10.10.10.x), (10.10.11.x), and (10.10.12.x). The IP addresses of the ports 0 and 1 of the router 10_1 are respectively (10.10.10.1) and (10.10.11.1). The IP addresses of the ports 0 and 1 of the router 10_2 are respectively (10.10.10.2) and (10.10.12.1).

The network devices 10_1 and 10_2 transmit a management information notification packet 70 including the management information of their own devices to the network management device 20, e.g. (1) at a startup, (2) upon occurrence of an error, (3) when the management information is changed, or (4) periodically, as a predetermined event.

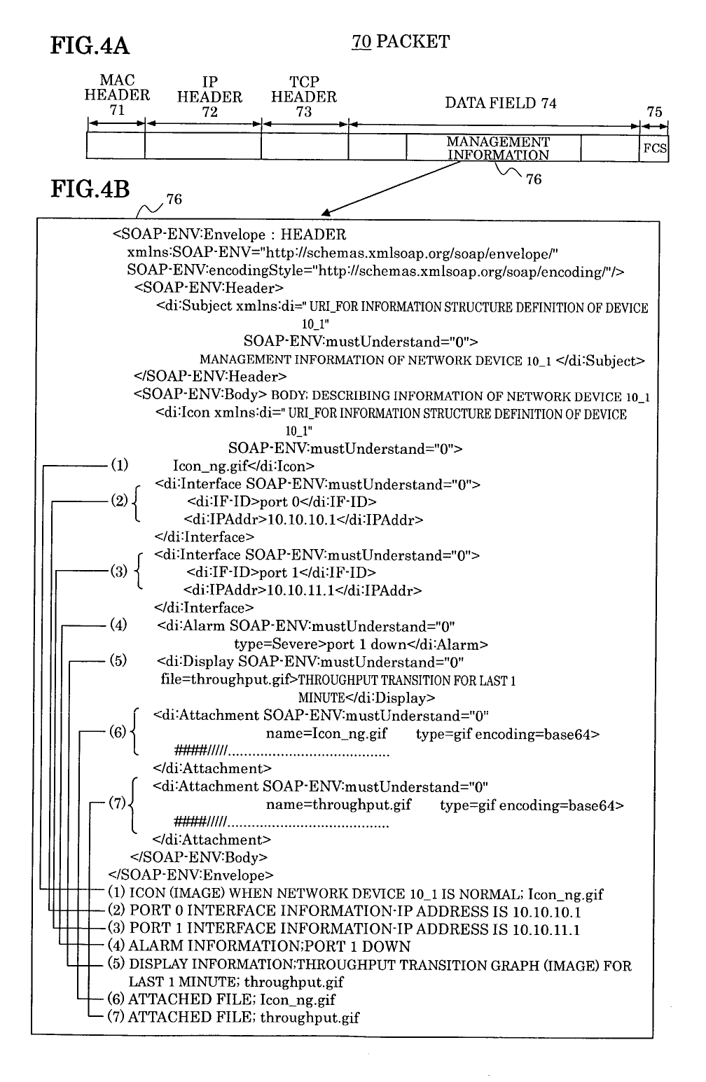

FIG. 4A shows an arrangement of the management information notification packet 70 transmitted by the network device 10_1. This packet 70 is composed of a MAC header 71, an IP header 72, a TCP header 73, a data field 74, and an FCS 75. Management information 76 is included in the data field 74.

FIG. 4B shows an example of the management information 76 shown in FIG. 4A. This management information 76 is described by XML format, and includes (1) icon of the network device 10_1 (Icon_ng.gif: image file while the device is normal), (2) port 0 of the network device 10 and its IP address=10.10.10.1, (3) port 1 and its IP address=10.10.11.1, (4) alarm information: failure of port 1, (5) display information: throughput transition graph (image file indicating throughput transition for last one minute), (6) attached file: Icon_ng.gif, and (7) attached file: throughput.gif.

In the network management device 20 (see FIG. 2), the network management processor 21 holds the management information 76 included in the management information notification packet 70 received from the packet receiver 27 in the management information storage 23.

The management information processor 24 refers to the management information storage 23 to execute a network management application. Namely, the management information processor 24 displays the following example (1) or (2): Display example (1): the management information received from each network device 10 is displayed on the display 25 sequentially tiled on the screen; Display example (2): the management information received from each network device is checked, and a logical connection of the network device 10 is determined based on a respective IP address (attribute is <di:IPAddr>) to be displayed as a network arrangement.

At this time, the management information processor 24 uses an image file designated by the attribute <di:Icon> within the received management information 76 for the network arrangement.

Also, when each icon of the network arrangement is clicked, the management information processor 24 makes the management information of the network device corresponding to the clicked icon displayed.

Furthermore, when the management information of the attribute <di:Alarm> is received and when “alarm is transmitted”, the management information processor 24 executes alarm transmission processings such as the followings (1)-(3): (1) Alarm sound is transmitted; (2) The device where an error has occurred is flashed on the screen; (3) Mail notification or the like is transmitted to the network administrator.

The management information processor 24 requests the management information generator 22 to inquire the network device to which a subsequent notification packet 70 has not reached even after a predetermined time has elapsed, from e.g. the network device which has been receiving the notification packet 70 so far. The management information generator 22 transmits a management information request packet 80. In the absence of the response thereto, the management information processor 24 determines that the network device 10 is down or failed.

Also, the management information processor 24 may request the management information generator 22 to transmit the management information request packet 80 to the network device according to the circumstances, after power-on, after a reset, at a specific time such as noon, or when determining that there is management information to be preferably obtained based on the obtained management information.

It is to be noted that while the XML is used in FIG. 4B, as an example of a description format of the management information, the description of the management information may be given by the HTML (Hyper Text Markup Language). However, since the HTML can not define the attribute, the management information processor 24 (network management application) only “displays sequentially tiled on the screen”, as mentioned in the above display example (1).

Also, as for the management information transmitted from the network device 10, a value can be changed depending on the then states, in which two kinds of icons indicating the normal state and the abnormal state, for example are prepared so that they can be included in the management information to be transmitted according to the states.

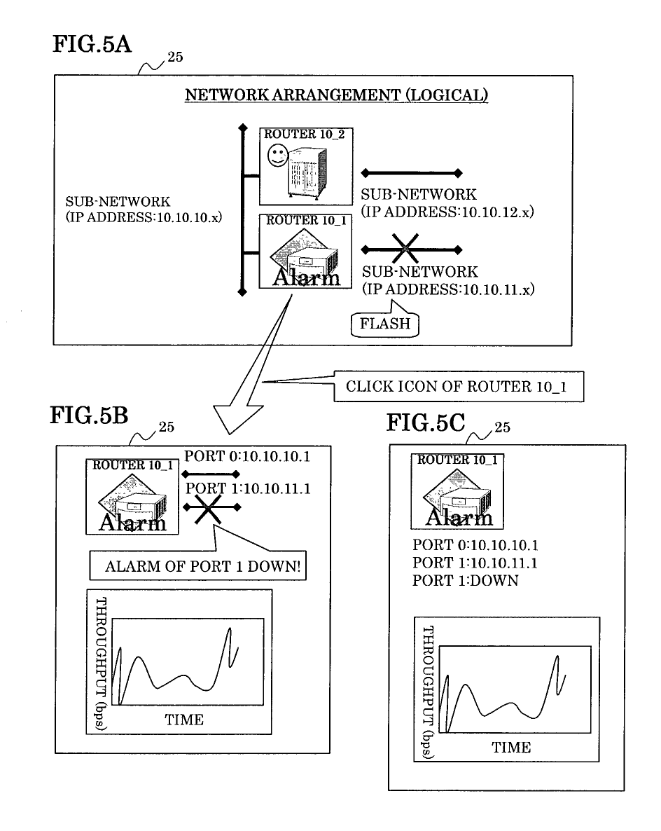

FIGS. 5A-5C show an example of a management screen displayed on the display 25. FIG. 5A shows a network composed of the network devices (routers) 10_1 and 10_2. FIG. 5B shows a screen displayed when the router 10_1 on the screen in FIG. 5A is clicked, in which the management information of the router 10_1, i.e. the icon of the router 10_1, an alarm indication indicating that the port 1 is down, and a throughput transition is displayed.

FIG. 5C shows, in the same way as FIG. 5B, a screen displayed when the router 10_1 on the screen of FIG. 5A is clicked. This screen indicates the case where the screen is simply displayed without interpreting the attribute of the management information described by the XML.

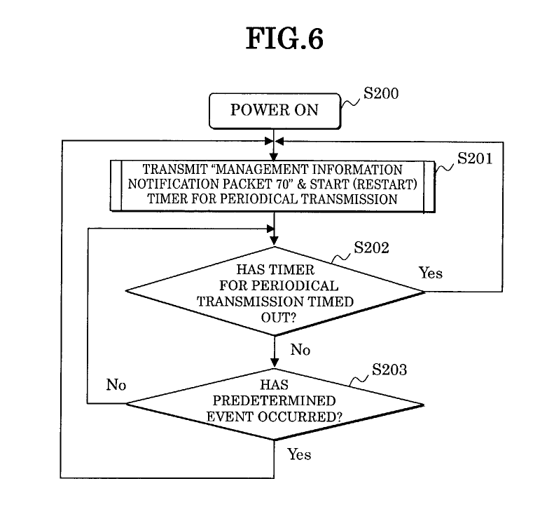

FIG. 6 is a flow chart showing an operation of the network device (router) 10.

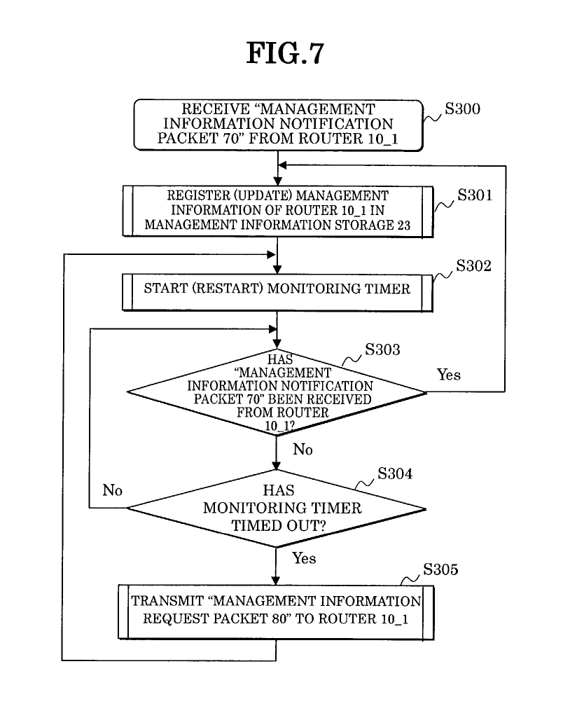

FIG. 7 is a flow chart showing an operation of the network management device (server) 20.

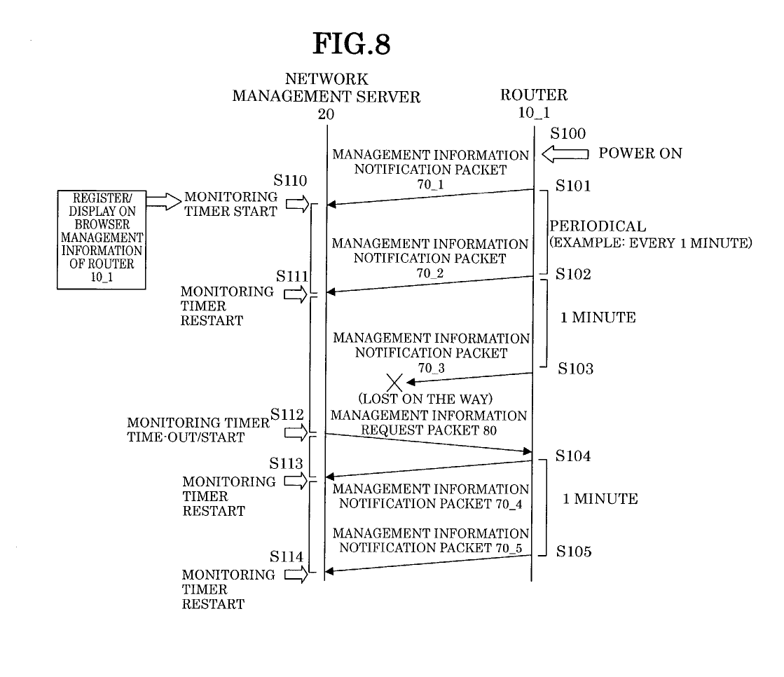

FIG. 8 shows an example of an operation sequence between the network device 10_1 and the network management device 20. Hereinafter, this operation sequence will be described referring to FIGS. 6 and 7.

Step S100: The power is turned “ON” in the router 10_1 (see step S200 in FIG. 6).

Step S101: In the router 10_1 (see FIG. 1), the management information generator 12 transmits a management information notification packet 70_1 (hereinafter, occasionally represented by a reference numeral 70) including the management information of its own device, and starts a timer for periodical transmission (not shown in FIG. 1) (see step S201 in FIG. 6).

This timer for periodical transmission is for periodically transmitting the management information notification packet 70 (e.g. every one minute).

Step S110: In the network management device 20 (see FIG. 2), the management information processor 24 receives the notification packet 70_1 through the packet receiver 27 (see step S300 in FIG. 7).

Also, the management information processor 24 registers the management information included in the notification packet 70_1 in the management information storage 23 and displays the same on the display 25 (see step S301 in FIG. 7). Furthermore, the management information processor 24 starts a monitoring timer (not shown in FIG. 2) (see step S302 in FIG. 7).

This monitoring timer is for monitoring whether or not the management information notification packet 70 is periodically received from the router 10_1.

Step S102: When the timer for periodical transmission has timed out (see step S202 in FIG. 6), namely one minute after the transmission of the notification packet 70_1, the management information generator 12 transmits a notification packet 70_2 including the latest management information 76 of its own device, and restarts the timer for the periodical transmission (see step S201 in FIG. 6).

Step S111: The management information processor 24 updates the management information of the router 10_1 stored in the management information storage 23 by the management information 76 included in the received notification packet 70 2, and displays the management information 76 on the display 25 (see steps S303 and S301 in FIG. 7). Furthermore, the management information processor 24 restarts the monitoring timer (see step S302 in FIG. 7).

Step S103: Further one minute later, in the same way as step S102, the management information generator 12 transmits a notification packet 70_3 including the latest management information 76, and restarts the timer for periodical transmission (steps S202 and S201 in FIG. 6).

The operation in case where the notification packet 70_3 is lost on the way and so does not reach the network management server 20 will now be described.

Step S112: In the network management server 20, the monitoring timer times out (steps S303 and S304 in FIG. 7). The management information generator 22 transmits the management information request packet 80 to the router 10_1 through the packet transmitter 26, and restarts the monitoring timer (see steps S305 and S302 in FIG. 7).

Step S104: In the router 10_1, the management information generator 12 receives the request packet 80 through the packet receiver 16 (a predetermined event occurs), transmits a notification packet 70_4 including the management information of its own device to the network management server 20, and restarts the timer for periodical transmission (steps S203 and S201 in FIG. 6).

Step S113: In the same way as step S110, the management information is displayed on the display 25 and the monitoring timer is started.

Steps S105 and S114: In the same way as steps S102 and S111, the management information of the router 10_1 is transmitted by a notification packet 70_5 and displayed on the display 25 of the network management server 20.

It is to be noted that in the above-mentioned embodiment, the routers 10_1 and 10_2 in FIG. 3 are the network devices according to the present invention and the case where the network devices are managed by the network management device has been described above. However, clients 50_1 and 50_2 are provided with the network management processor for transmitting the management information of its own device by a format displayable on a browser to the network management device 20, whereby the network management device 20 can manage the clients 50_1 and 50_2.

As described above, a network device and a network management device according to the present invention are arranged such that a network management processor of the network device transmits management information of its own device in a format displayable on the browser, e.g. an XML or an HTML upon occurrence of a predetermined event, and a network management processor of the network management device displays the management information. Therefore, it becomes possible for the network device to easily transmit the management information of its own device to the network management device.

Also, the network device can transmit the optimal management information for the management of its own device, the unique management information, and the like by the optimal display format. Also, the network management device is provided with the minimum browser function, thereby enabling the network device to be managed.

Furthermore, it becomes possible for the network management device to manage e.g. the management information unique to a newly added network device without changing management applications.

More specifically, when new products of the network device are shipped, a new function is added to the network device, or the like, it was difficult to immediately reflect its new management information to the network management application. However, if the network device and the network management device of the present invention are used, it will be possible to perform a network management to the new management information in this case.

Also, since the management information is transmitted to the network management device under the initiative of the network device, the optimal management information for each network device, e.g. an icon according to each device, the management information concerning a support function unique to the network device, or the like can be displayed on the network management device.

Furthermore, the management of the network device can be realized without buying a network management device and a network management application with a high function.

What we claim is:

1. A network device comprising:
a network management processor for preparing management information of its own device in a format displayable on a browser upon occurrence of a predetermined event; and
a transmitter for transmitting the management information.

2. The network device as claimed in claim 1 wherein the network management processor comprises a management information storage for holding the management information and a management information generator for generating management information of a format displayable on the browser based on the management information.

3. The network device as claimed in claim 1 wherein the format displayable on the browser comprises an HTML or an XML.

4. The network device as claimed in claim 1 wherein an attribute is added to the management information.

5. The network device as claimed in claim 1 wherein the occurrence of the predetermined event comprises at least one of a time of a startup, a time of a management information change, or a predetermined period.

6. The network device as claimed in claim 1 wherein the occurrence of the predetermined event comprises a time when a management information request packet is received from a network management device.

7. A network management device comprising:
a receiver for receiving management information of a format displayable on a browser transmitted from a network device upon occurrence of a predetermined event; and
a network management processor for displaying the management information.

8. The network management device as claimed in claim 7 wherein the network management processor has a management information storage for storing received management information of the format and a management information processor for displaying management information based on the management information.

9. The network management device as claimed in claim 7 wherein the network management processor generates a management information request packet requesting management information determined to be necessary and transmits the packet to the network device.

10. The network management device as claimed in claim 8, further comprising a management information generator for transmitting a management information request packet requesting the management information to the network device, when subsequent management information is not received from the network device after the management information of the network device is received and a predetermined time elapses.

11. The network management device as claimed in claim 8 wherein the management information processor displays each management information from a plurality of network devices respectively on a window screen corresponding to each network device.

12. The network management device as claimed in claim 8 wherein the management information processor displays the management information based on an attribute added to the management information of the format.
